(19) United States
(12) Patent Application Publication
(10) Pub. No.: US 2026/0274309 A1
(43) Pub. Date: Sep. 17, 2026

(54) METHOD FOR PREDICTING EXPECTED ROAD SURFACE TEMPERATURES

(71) Applicant: MERCEDES-BENZ GROUP AG, Stuttgart (DE)

(72) Inventors: Timo ESPENSCHIED, Leonberg (DE); Patrick BLUME, Königswinter (DE); Wiebke LOOGEN, Stuttgart (DE)

(21) Appl. No.: 19/166,989

(22) PCT Filed: Feb. 27, 2024
(86) PCT No.: PCT/EP2024/055013

§ 371 Date: Sep. 19, 2025

(30) Foreign Application Priority Data
Mar. 20, 2023 (DE) 10 2023 001 090.1

(51) Int. Cl. B60W 60/00; B60W 50/00; G08G 1/01

(52) U.S. Cl. CPC B60W 60/0059; B60W 50/0097; G08G 1/0112; G08G 1/0141; B60W 2555/20

(57) ABSTRACT

Expected road surface temperatures for at least one road section are predicted. Surface temperatures of a road surface in the road section are measured via a sensor. Environmental information is assigned to the measurement and together with the surface temperatures is sent to a backend. A connection between the environmental information and the surface temperatures is learned by means machine learning so that expected road surface temperatures can be estimated.

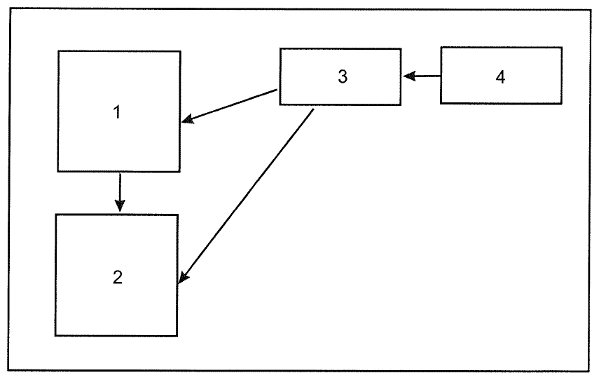

### BACKGROUND AND SUMMARY OF THE INVENTION

Exemplary embodiments of the invention relate to a method for predicting expected road surface temperatures for at least one road section.

A method for creating a digital map is known from DE 10 2015 000 394 A1, wherein location-dependent estimate values of a physical measured variable are recorded in the digital map. Measurement data relating to the road state, and for example data about the temperature, can be collected via a vehicle fleet. This data can be transmitted to a server by means of mobile radio and is processed from there. A digital map with the assigned collected data can be transmitted to the vehicles so that a road state can be provided to the driver assistance system depending on the location on the map. The driver assistance system can switch functions on or off depending thereon, and thus respond to environmental conditions.

DE 10 2019 135 751 A1 describes a generic method for predicting expected road surface temperatures for at least one road section, wherein surface temperatures of a road surface in the road section are measured via at least one sensor. Environmental information is assigned to the measurement and together with the surface temperatures is sent to a backend. A connection between the environmental information and the surface temperatures is learned by means of machine learning, so that expected road surface temperatures can each be estimated as fixed values.

DE 10 2020 004 018 A1 describes enabling an autonomous driving function as a function of temperature conditions.

The disadvantage is that only data that has already been measured is input into the system. A prediction for future situations can therefore not be made. However, a situation in the future is particularly advantageous for adapting functions provided by the driver assistance system, in order to act economically, sustainably and proactively.

Exemplary embodiments of the present invention are directed to a method for predicting expected road surface temperatures, wherein future data that cannot be measured directly on the spot can also be determined.

The core of the method according to the invention is that surface temperatures of a road surface in the road section are measured via at least one sensor, wherein environmental information is assigned to the measurement and together with the surface temperatures is sent to a backend, wherein a connection between the environmental information and the surface temperatures is learned by means of machine learning, so that expected road surface temperatures can be estimated. An interval providing a maximum and a minimum possible value of the road surface temperatures depending on the location is provided as an output value. Uncertainty in the prediction of the values can therefore be quantified and be better estimated. In contrast, only the value of the surface temperature is used as a so-called point estimate in the case of known systems. With the method provided now, it can advantageously be ensured how well the estimate approximates the actual value.

The method for predicting expected road surface temperatures for at least one road section makes it possible, for example, to create a current road surface temperature map and to make a prediction about how the data of the road surface temperature map will behave for a certain time period. Such a map can be advantageous for road management, for example, in particular for winter management of the road operator to ensure infrastructure security. In particular, however, the function capability of driver assistance systems is increased. For example, availability of level 3 to 5 driving functions can therefore be substantially increased, as precise information about the surface state and future values is available, whereby premature disconnection of the system can be avoided. Therefore, advantageously, a current restriction on the use of automated driving can be expanded by the method, whereby the automated functions can be used in significantly more situations and safety-critical information can be displayed early on. Advantageously, infrastructure operators can also better maintain roads faster and more cost-effectively, as conclusions can be drawn about the road state by predicting the road surface temperature over time. Then existing gaps in knowledge can be closed due to the high data density. In particular, this offers advantages in relation to the previously known stationary measurements.

Due to the use of machine learning, surface temperatures can be determined, which represent limit values or are critical for specific local conditions of different aggregate states, such as, for example, wet conditions or ice. Therefore, more precise predictions for the state of the road can be made. Then both vehicle-external applications as well as vehicle-internal applications can respond appropriately, in order to adapt the driving behavior to the state of the road.

Actual recognition of the road surface temperature based on the data available can firstly take place in the backend, for example. The recognition can therefore be dependent on different requirements, such as for example a transmission capacity and an on-line computing capacity. Based on the collected data, a machine learning model can be trained, which, for example, outputs a prediction interval by using a conformal prediction and thus predicts uncertainty of the machine learning model. The data is therefore output preferably as data of an interval.

The machine learning model can be trained initially on development vehicles with a corresponding sensor system that can measure the road surface temperature. The backend is supplied in the process with information or data from a plurality of different vehicles, such that an environment map can be created.

Preferably, the expected road surface temperatures for future points in time can be determined by means of a conformal prediction algorithm, wherein uncertainty of the machine learning data is determined. Thus, the current road surface temperature and a development over time of the road surface temperature can be estimated at specific geo-positions experimentally and very accurately due to a large data density. In particular, therefore the output of a prediction interval is used, which qualifies the limits of machine learning. Therefore, for example, a split conformal prediction, a full conformal prediction, or a method that lies between the two approaches, such as for example a cross-conformal prediction or jackknife, can be used as conformal prediction approaches.

According to a very advantageous development of the idea, it can be provided that the environmental information is geo-positions and times. Therefore, the data can be assigned to a concrete location at a specific time. The environmental information can originate, for example, from a measurement sensor system on the vehicle itself. Furthermore, environmental information taken from weather stations or from data measured by the road operator can be used. States, such as sun intensity, rainfall and snowfall and, in particular, air temperature can be included in the environmental information. For this purpose, sensors and/or cameras, and a wireless connection, for example via mobile radio, can be used in order to convey the data to a backend server. The entirety of all this data, where data from German weather services can also be included, can be collected anonymized in the backend.

In this case, according to an advantageous embodiment, it can be provided that further data is measured by means of an on-board sensor system of a vehicle, which further data together with the environmental information and the surface temperatures is sent to the backend. Therefore, improved geographic coverage of weather data can be provided. In particular, the sensor system can be located only a very small distance from the road surface, so that in particular the data of the road surface can be specified very precisely.

According to a very advantageous development of the idea, it can be provided that data of a road operator is used and similarly is sent to the backend. In this case, similarly, publicly accessible weather data from stationary measurements can be consulted. All of this data increases the data density, so that the system can work even more accurately.

A further advantageous embodiment can provide that the conformal prediction algorithm aggregates a set of data and splits it with equal distribution into a training set, a test set and a calibration set.

According to a very advantageous development of the idea, it can be provided that machine learning takes place on the basis of the training set.

According to an advantageous embodiment, it can be provided that a score function is defined, which defines how unusual a data set is in relation to a previous data set. Calibration scores can be calculated with the previously defined calibration set. In this case, a defined quantile function of the calibration score can be calculated. The quantile can, in particular, be used to calculate prediction intervals for new examples, so that in particular marginal coverage is fulfilled. In other words, this means the calculation of a probability, wherein the probability that the prediction intervals include the correct label can be specified with 1-alpha, wherein alpha is in [0.1].

Such approaches result in particular in the advantages that data only has to be split into training and test sets. In this case, for example, an AI model is trained on the training data set. A calibration data set can be omitted, with the selection of this data set being difficult. Furthermore, learning a scoring function can be omitted, as this can be trained or selected.

A further advantageous embodiment can provide that a map with information about road surface temperatures is created, wherein data of a vehicle fleet is used. Furthermore, the created map can be provided to each vehicle in the fleet, wherein these vehicles in particular have to comprise sub-systems, in order to transmit or receive the data contributing to the determination of the map.

According to a very advantageous development of the idea, it can be provided that an autonomous driving function is or is not enabled depending on determined current and future road surface temperatures. The autonomous driving functions can be used on a large scale and have to be deactivated less often. In particular, this comprises the availability of level 3 to 5 vehicle functions, which is substantially increased. Then, the information can be used to expand autonomous driving. Furthermore, infrastructure operators can use the information to better maintain their road networks.

Further advantageous embodiments of the method according to the invention for predicting expected road surface temperatures result from the exemplary embodiment which is represented in more detail below with reference to the figure.

### BRIEF DESCRIPTION OF THE SOLE DRAWING FIGURE

The sole drawing figure is a schematic representation of the sequence of the method.

### DETAILED DESCRIPTION

In the representation of the sole drawing figure, a possible sequence of the method is schematically represented. In a step marked with 1, on-board data of a plurality of vehicles can be measured and stored, which data is measured, for example, via the respective sensor system on the vehicle. The data can be combined via a communication module with off-board data which is determined in a step marked with 2. This so-called off-board data can include data about environmental states and geo-positions, which are not measured by the vehicle, marked with step 3. In this case, data from a weather provider can be passed by a step marked with 4 to the data. Therefore, returning to step 2, a road surface temperature can be determined, wherein the data can be determined via artificial intelligence.

For example, environmental variables can be aggregated at a point in time t in the backend and the behavior of the road surface temperature for future points in time t+n, where n is a natural number, can be predicted with an AI model. In this case, for example, the following predictions can be made. In the case of a large interval, an AI model is uncertain and the model has difficulty making a decision. To improve this, more data needs to be collected or data needs to be homogenized. In the case of a small interval, the AI model is very certain, wherein a very good approximation of the reality can take place.

In other words, therefore, a connection is made between environmental variables and the road surface temperature with the AI model, wherein any uncertainty of the model can be quantified with a conformal prediction. In summary, therefore, a method for determining, providing and predicting geo-localized road surface temperatures can be provided.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
measuring, using at least one sensor, surface temperatures of a road surface in a road section;
assigning environmental information to the measured surface temperatures;
transmitting the measured surface temperatures and assigned environmental information to a backend;
learning, by the backend using machine learning, a connection between the assigned environmental information and the surface temperatures;
estimating, using the learned connection between the assigned environmental information and the surface temperatures, expected road surface temperatures of the road section at future points in time;
creating, by the backend, an interval with a maximum and a minimum possible value of the expected road surface temperature on the road section; and
outputting, by the backend, the interval.

12. The method of claim 11, wherein the expected road surface temperatures at the future points in time are determined using a conformal prediction algorithm, which determines an uncertainty of data used by the machine learning.

13. The method of claim 11, wherein the environmental information is geo-positions and times of the measurement of surface temperatures of the road surface in the road section.

14. The method of claim 11, further comprising:
measuring, using an on-board sensor system of a vehicle, further data, wherein the further data is sent to the backend together with the environmental information and the surface temperatures.

15. The method of claim 11, wherein data of a road operator sent to the backend.

16. The method of claim 12, wherein the conformal prediction algorithm aggregates a set of data and splits the set of data with equal distribution into a training set, a test set, and a calibration set.

17. The method of claim 16, wherein the machine learning uses the training set.

18. The method of claim 16, wherein a score function is defined, which defines how unusual a data set is in relation to a previous data set.

19. The method of claim 11, further comprising:
creating a map with information about road surface temperatures; and
distributing the map to vehicles in a vehicle fleet, wherein the vehicles use the map.

20. The method of claim 11, further comprising:
disabling an autonomous driving function of a vehicle based on determined current and future road surface temperatures.
